(19) United States
(12) Patent Application Publication
(10) Pub. No.: US 2003/0042268 A1
(43) Pub. Date: Mar. 6, 2003

(54) Merchandise dispensing system and associated methods

(76) Inventors: Grandai Srinivasan, Windemere, FL (US); Jaya Srinivasan, Windemere, FL (US)

Correspondence Address: JEFFERY S. WHITTLE, ALLEN,DYER,DOPPELT, MILBRATH & GILCHRIST, PA, 255 S. ORANGE AVENUE SUITE 1401, P.O.BOX 3791, ORLANDO, FL, 32802-3791, US

(21) Appl. No.: 09/941,962

(22) Filed: Aug. 29, 2001

(51) Int. Cl. G07F 11/00

(52) U.S. Cl. 221/24

(57) ABSTRACT

A merchandise dispensing system and device are provided. The merchandise dispensing device is positioned in a preselected environment and includes a main body, a rotatable display positioned in the main body, and an outer thematic facade corresponding to the preselected environment and positioned to connect to the main body. The merchandise dispensing system includes a main body and a plurality of outer thematic facades connected thereto. The merchandise dispensing system also includes a server, a communications network positioned in communication with the server, and a plurality of merchandise dispensing devices positioned in communication with the server.

### RELATED APPLICATIONS

The present application claims the benefit of Provisional Patent Application Serial No. ______, filed on Jul. 12, 2001, titled, Methods Of Displaying And Selling Jewelry In High Traffic Areas which is incorporated herein in its entirety by reference.

### FIELD OF THE INVENTION

The present invention relates to the field of merchandise dispensing systems for dispensing valuable merchandise and methods of dispensing merchandise.

### BACKGROUND OF THE INVENTION

Merchandise dispensing devices, such as vending machines, are typically used to dispense low-cost merchandise, such as sodas, snacks, candy, costume jewelry, i.e., plastic rings and necklaces, or stickers. It is also known to dispense greeting cards, film, or even “Matchbox” cars, crayons, and markers from vending machines. Current vending machines typically have a plastic cover portion that covers the inner portions of the vending machine. The plastic cover portion can generally include an advertisement for the merchandise positioned therein. For example, if the merchandise positioned in the vending machine is soda, then the brand of the soda is displayed on the outer plastic portion. This is disadvantageous because the user generally does not have the opportunity to view the product that is being purchased, i.e., the products are not visible to the user because they are positioned behind the outer plastic portion.

It is also known to provide an outer facade positioned to cover a vending machine. The outer facades that have been used, however, cover the vending machine in such a way that users do not even realize that a vending machine is positioned beneath the outer facade. Another problem that exists with current outer facades is that the outer facade is positioned so that the vending machine is substantially covered making it difficult to determine what type of merchandise is being dispensed from the particular vending machine. The user normally must approach the vending machine and search for what product is being dispensed from the vending machine. This is disadvantageous because it requires excess time from the user to determine whether there is a product associated with the vending machine, and if so, what the product is. A user purchasing merchandise from a vending machine typically will not take the time to try to figure out what type of merchandise is being sold.

It is also known to provide a vending machine that displays a plurality of articles of merchandise to the user before the user purchases the merchandise, i.e., the classic gum-ball machine. The gum-ball machine generally displays a plurality of stickers or plastic jewelry, for example, that are available for purchase. A user then inserts a predetermined payment, $0.25 for example, and one of the plurality of stickers or plastic articles of jewelry are dispensed to the user. This is disadvantageous because the user generally has no control over which sticker will be dispensed. Therefore, a user cannot choose which article of merchandise that will be dispensed, but rather gambles on the hope that the article of merchandise desired is dispensed.

Another problem with current vending machines is that the merchandise dispensed from the machines are sometimes inadequately displayed in the machine. This is especially a problem for items that tend to have elevated costs associated therewith. When a customer sets out to purchase items having a higher cost, an important factor in making the customer's decision is the ability to readily view the merchandise. Current vending machines generally do not adequately display the merchandise to be sold to the customer and sometimes do not display the merchandise at all.

Yet another problem with current vending machines is that they can appear to be out of place when positioned in a certain environment. For example, a beverage vending machine having advertising positioned on the outer body portion positioned in the middle of a zoo would be out of place. This type of vending machine is disadvantageous to the owner of the zoo because it takes away from the aesthetical appearance of the zoo.

One problem that arises in the sale of valuable merchandise, i.e., merchandise having a value over $500, is theft. Theft occurs both internally, i.e., employee theft, and also externally, i.e., customer theft. One of the biggest risk factors is the handling of the merchandise. The greater the number of persons that handle valuable merchandise, the greater the risk that theft will occur.

### SUMMARY OF THE INVENTION

With the foregoing in mind, the present invention advantageously provides a merchandise dispensing system having a merchandise dispensing device positioned in a preselected environment. The merchandise dispensing system and device of the present invention advantageously allows a user to readily view the merchandise in a viewing area. The merchandise dispensing system and device of the present invention also advantageously eliminates the problem of not providing a user with an adequate view of the merchandise positioned in the merchandise dispensing device by rotating the merchandise in a plurality of predetermined directions. The present invention advantageously allows for merchandise having higher costs associated therewith to be dispensed from the merchandise dispensing device because the merchandise is readily viewable to the user. The present invention further advantageously allows for a merchandise dispensing device to be positioned in a preselected environment without taking away from the aesthetic appearance of that environment.

More particularly, the present invention includes a merchandise dispensing device positioned in a preselected environment for dispensing merchandise. The merchandise dispensing device includes a main body having a plurality of articles of merchandise positioned therein. The main body includes at least one main body viewing area that is substantially transparent so that the plurality of articles of merchandise can be readily viewed from a position exterior the main body.

The merchandise dispensing device also includes an outer thematic facade connected to and substantially covering portions of the main body. The outer thematic facade corresponds to the preselected environment so that the outer thematic facade has an appearance that blends into the preselected environment. The outer thematic facade includes at least one outer thematic facade viewing area that is substantially transparent and positioned to align with the at least one main body viewing area so that the plurality of articles of merchandise positioned in the main body can be readily viewed from a position exterior the outer thematic facade. The merchandise dispensing device further advantageously includes a display device positioned along portions of the outer thematic facade for displaying preselected images to users to thereby draw the attention of users to the merchandise dispensing device.

The merchandise dispensing device still further advantageously includes a payment receiving device positioned to connect to portions of the main body for receiving a predetermined payment for at least one of the plurality of articles of merchandise, and a user interface responsive to a user and positioned along portions of the main body so that a user can select one of the plurality of articles of merchandise to be viewed and purchased. The merchandise dispensing device further advantageously includes a dispenser positioned to connect to portions of the main body for dispensing at least one of the plurality of articles of merchandise selected by a user.

The present invention also advantageously includes a merchandise dispensing device including a main body having a plurality of articles of merchandise positioned therein. The merchandise dispensing device also includes at least one main body viewing area positioned on the main body. The at least one main body viewing area is advantageously substantially transparent so that the plurality of articles of merchandise positioned within the main body are readily viewable from a position exterior the main body. The merchandise dispensing device of the present invention also advantageously includes a rotatable display positioned within the main body for rotatably displaying the plurality of articles of merchandise positioned in the main body, and a payment receiver positioned along outer portions of the main body for receiving a predetermined payment for at least one of the plurality of articles of merchandise. The merchandise dispensing device further advantageously includes a user interface responsive to a user and positioned along outer portions of the main body so that a user can select one of the plurality of articles of merchandise to be viewed and purchased and a dispenser positioned along outer portions of the main body for dispensing at least one of the plurality of articles of merchandise.

The present invention further advantageously includes a merchandise dispensing system for dispensing merchandise. The merchandise dispensing system includes a server having a database, a communications network positioned in communication with the server, and a plurality of merchandise dispensing devices. Each of the merchandise dispensing devices can advantageously be positioned in one of a plurality of preselected environments and further positioned in communication with the communications network. Each one of the plurality of merchandise dispensing devices includes a main body and an outer thematic facade connected thereto. The main body advantageously includes a plurality of articles of merchandise positioned therein and the outer thematic facade advantageously includes a display device connected along outer portions thereof for displaying preselected images to users to thereby draw the attention of users to each one of the plurality of merchandise dispensing devices. Each of the merchandise dispensing devices further includes a dispenser positioned to connect to portions of the main body for dispensing at least one of the plurality of articles of merchandise selected by a user. The merchandise dispensing system also advantageously includes a monitor positioned on the server and in communication with the communications network for monitoring the plurality of articles of merchandise positioned in the main body portion of each one of the plurality of merchandise dispensing devices.

The present invention still further advantageously includes a method of dispensing a plurality of articles of merchandise from a merchandise dispensing device. The method includes rotating the plurality of articles of merchandise on display in the merchandise dispensing device in a first predetermined direction. The method further includes rotating each of the plurality of articles of merchandise on display in the merchandise dispensing device in a second predetermined direction so that each one of the plurality of articles of merchandise is rotated in the second predetermined direction while simultaneously rotating the plurality of articles of merchandise in the first predetermined direction. The method further includes dispensing at least one of the plurality of articles of merchandise to a user.

The present invention also advantageously includes a method of dispensing merchandise from a merchandise dispensing device positioned in one of a plurality of preselected environments. The method includes displaying a plurality of articles of merchandise within a main body of a merchandise dispensing device. The method also includes interchangeably and detachably connecting one of a plurality of outer thematic facades to the main body of the merchandise dispensing device so that the merchandise dispensing device corresponds to the preselected environment in which the merchandise dispensing device is positioned. The method further includes dispensing at least one of the plurality of articles of merchandise to a user.

The present invention advantageously allows users to readily view merchandise from a plurality of different perspectives before purchasing the merchandise. The present invention further advantageously decreases, or nearly eliminates, the need for many persons to handle valuable merchandise, thereby decreasing the chances of theft. The present invention also advantageously allows a merchandise dispensing device to be positioned in a plurality of preselected environments without interfering with the aesthetic appearance of the preselected environments. The present invention still further advantageously eliminates the need for a plurality of sales associates and the square footage of an entire store to sell valuable merchandise. The present invention further advantageously draws the attention of users to the device by projecting an image on a display device positioned on an outer portion of the display device.

### BRIEF DESCRIPTION OF THE DRAWINGS

Some of the features, advantages, and benefits of the present invention having been stated, others will become apparent as the description proceeds when taken in conjunction with the accompanying drawings in which:

FIG. 1 is a perspective view of a merchandise dispensing device including an outer thematic facade according to the present invention;

FIG. 1A is a perspective view of an outer thematic facade being positioned on a main body of a merchandise dispensing device according to the present invention;

FIG. 2 is an environmental view of a merchandise dispensing device positioned in a preselected environment according to the present invention;

FIG. 3 is a perspective view of a merchandise dispensing device having a rotatable display according to the present invention;

FIG. 4 is a perspective view of a merchandise dispensing system having a plurality of outer thematic facades according to the present invention;

FIG. 5 is a perspective view of an outer thematic facade being positioned on a main body of a merchandise dispensing device according to the present invention;

FIG. 6 is a perspective view of a merchandise dispensing device having a rotatable display and an outer thematic facade according to the present invention;

FIG. 7 is a perspective view of a merchandise dispensing device having portions cut away to show the interior portions of the merchandise dispensing device according to the present invention;

FIG. 8 is a flow chart describing the display of merchandise positioned in the merchandise dispensing device according to the present invention;

FIG. 9 is a flow chart describing the customization of jewelry in a merchandise dispensing device according to the present invention;

FIG. 10 is an environmental view of a merchandise dispensing system according to the present invention;

FIG. 11A is a perspective view of a user selecting an article of merchandise and retrieving the article of merchandise from a dispenser;

FIG. 11B is a perspective view of a user selecting another article of merchandise according to the present invention.

### DETAILED DESCRIPTION OF THE PREFERRED EMBODIMENTS

The present invention will now be described more fully hereinafter with reference to the accompanying drawings which illustrate preferred embodiments of the invention. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, the prime notation, if used, indicates similar elements in alternative embodiments.

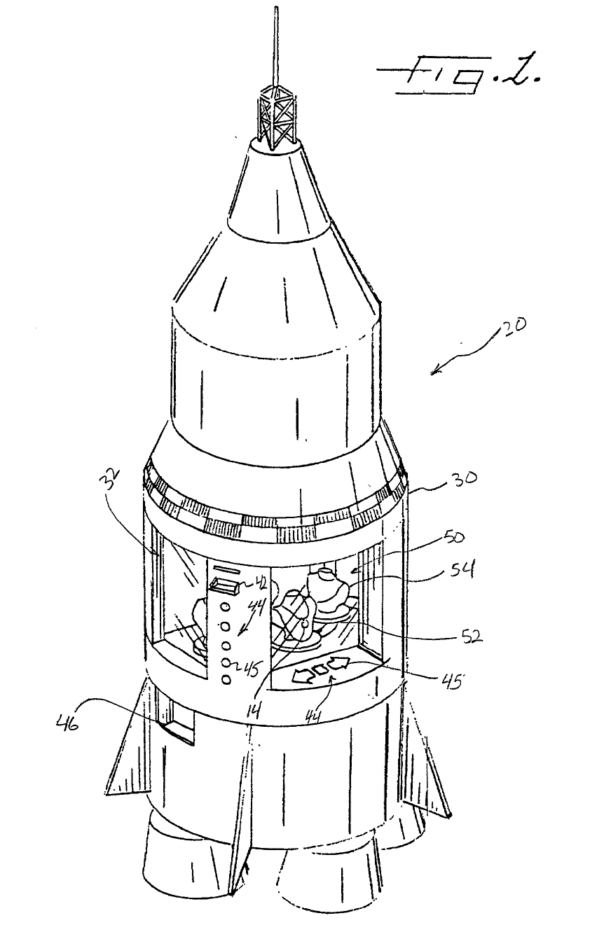

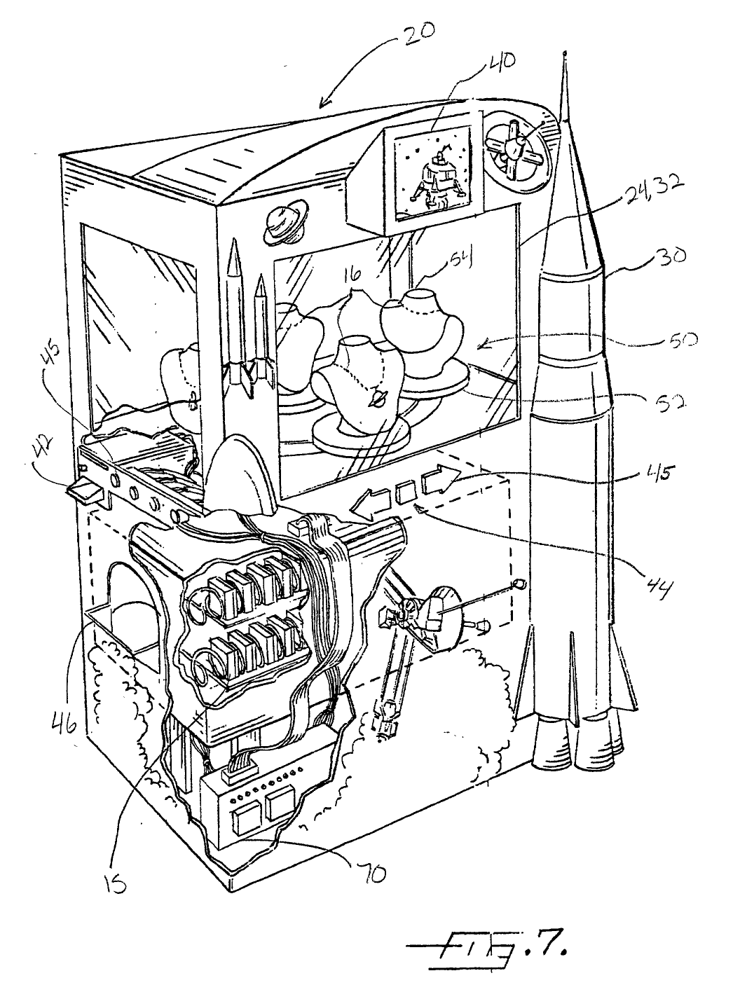

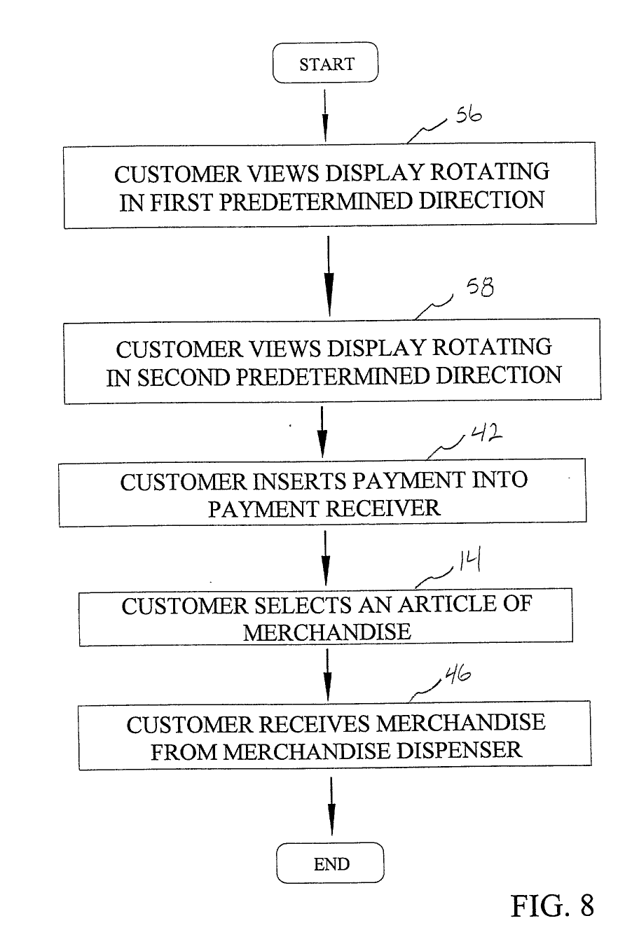

Referring to FIGS. 1-10, the present invention provides a merchandise dispensing system 10, a merchandise dispensing device 20, and methods for dispensing merchandise 14. More particularly, the merchandise dispensing device 20 of the present invention can advantageously be positioned in a preselected environment 12, such as a theme park, museum, or on a college campus, for example, and is preferably positioned in a high customer traffic area. This advantageously increases customer exposure to the merchandise dispensing device 20. The merchandise dispensing device 20 can advantageously include a main body 22 having a plurality of articles of merchandise 14 positioned therein. The plurality of articles of merchandise 14 can advantageously include valuable jewelry, i.e., greater than $500 in cost, or any other type of merchandise, such as watches, rings, necklaces, bracelets, scarves, perfumes, colognes, pens, pencils, T-shirts, cuff links, purses, wallets, and sunglasses for example, as understood by those skilled in the art.

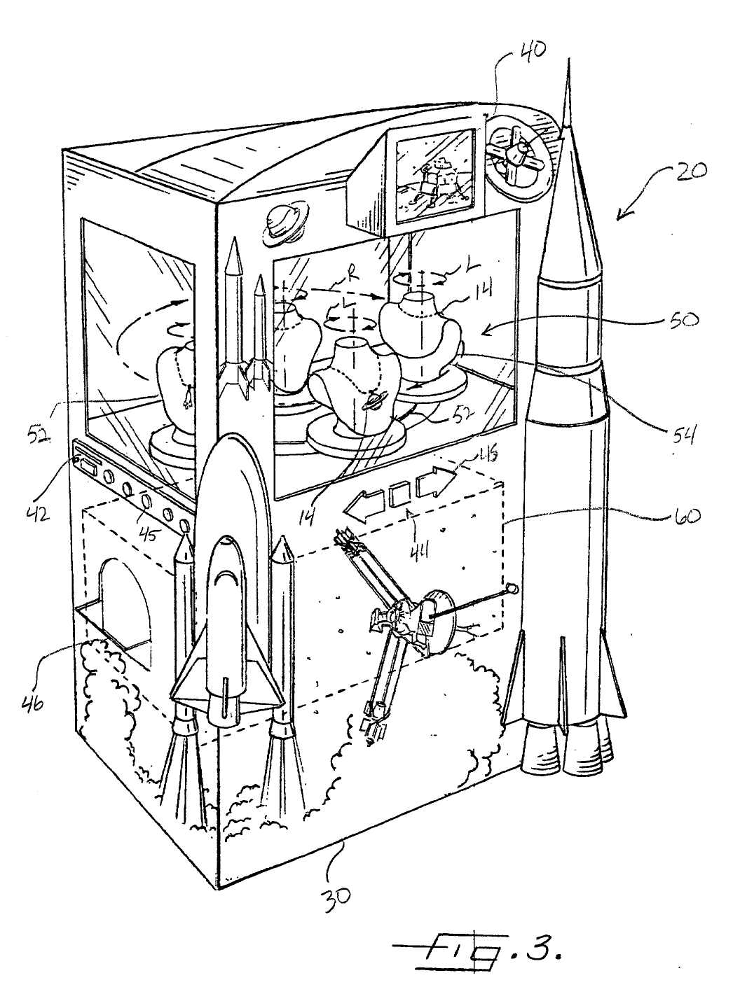

As illustrated in FIG. 4, the main body 22 includes at least one main body viewing area 24. The main body viewing area 24 can advantageously be positioned along an upper portion of the main body 22. One main body viewing area 24 can, for example, be positioned on each side of the merchandise dispensing device 20, i.e., one main body viewing area 24 positioned on the front portion of the main body 22, another viewing area 24 positioned on either side of the main body 22, and, yet another main body viewing area 24 positioned on a back portion of the main body 22. The plurality of main body viewing areas 24 advantageously allow a plurality of users U to use the merchandise dispensing device 20 when positioned adjacent any side of the merchandise dispensing device. The main body viewing area 24 is substantially transparent so that the plurality of articles of merchandise 14 can be readily viewed from a position exterior the main body 22. The main body viewing area 24 can be made of a strong glass material, plexi-glass, or any other material having high strength properties, and is also substantially transparent to thereby advantageously provide added security while still allowing users U to view the merchandise 14 positioned in the main body 22 of the merchandise dispensing device 20. The main body viewing area 24 is also preferably bullet-proof and highly impact resistant so as to withstand high impacts. This advantageously decreases the danger of theft or vandalism to the merchandise dispensing device.

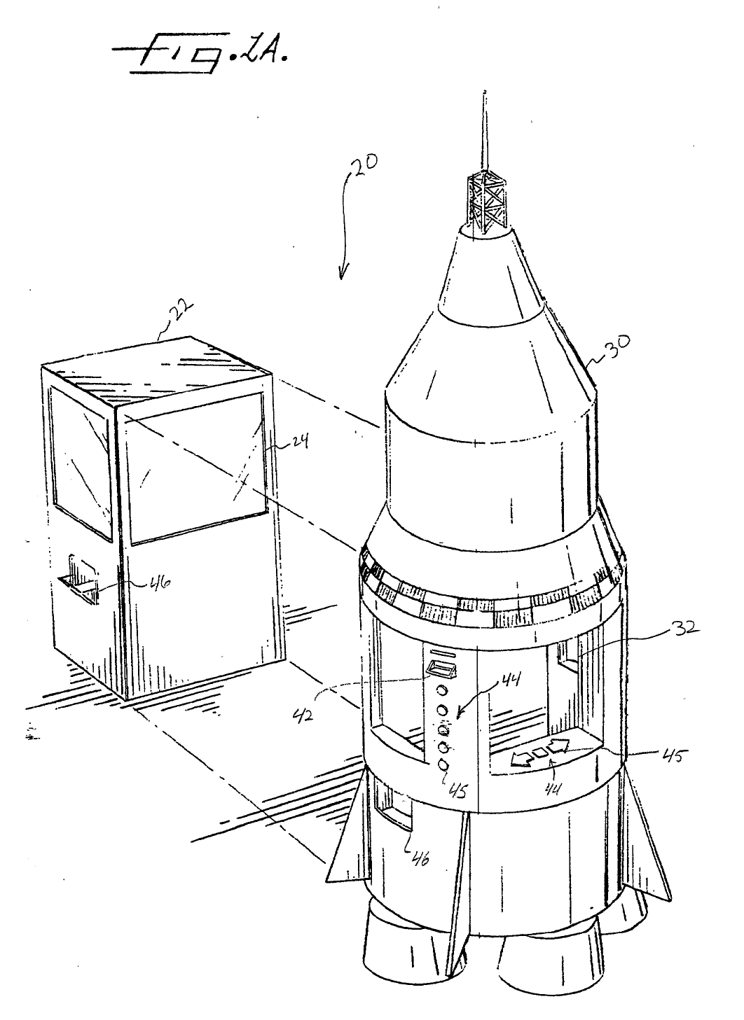

As perhaps best illustrated in FIG. 1, the merchandise dispensing device 20 can advantageously include an outer thematic facade 30 connected to and substantially covering portions of the main body 22. The outer thematic facade 30 corresponds to the preselected environment 12 in which the merchandise dispensing device 20 is positioned so that the outer thematic facade 30 has an appearance that blends into the preselected environment 12. For example, as best illustrated in FIG. 2, the preselected environment 12 can be a rocket museum and the outer thematic facade 30 can include a plurality of rockets and space-crafts. The merchandise dispensing device 20, therefore, will blend into the rocket museum and not decrease the aesthetical appearance desired by the owner of the museum.

As also illustrated in FIG. 1, the outer thematic facade 30 can advantageously include an outer thematic facade viewing area 32. Similar to the main body viewing area 24, the outer thematic facade viewing area 32 is also substantially transparent. Also similar to the main body viewing area 24, the outer thematic facade viewing area 32 can be made of strong glass material, plexi-glass or any other material having high strength properties and that is substantially transparent to thereby provide added security while still allowing users U to view the merchandise 14 positioned in the main body 22 of the merchandise dispensing device 20. The outer thematic facade viewing area 32 is also preferably bullet-proof and impact resistant so as to withstand high impacts. This advantageously decreases the risk of theft or vandalism to merchandise dispensing device 20.

The outer thematic facade viewing area 32 can advantageously be positioned along an upper portion of the outer thematic facade 30. Further, the outer thematic facade viewing area 32 is positioned to align with the main body viewing area 24. Therefore, if the outer thematic facade 30 advantageously includes an outer thematic facade viewing area 32 on each side of the outer thematic facade 30, i.e., an outer thematic facade viewing area 32 on the front portion of the outer thematic facade 30, an outer thematic facade viewing area 32 on either of the side portions of the outer thematic facade 30 and an outer thematic facade viewing area 32 on the back portion of the outer thematic facade 30, these viewing areas will be aligned with the main body viewing area 24 so as to prevent obstruction of both the main body viewing areas 24 and the outer thematic facade viewing areas 32. This advantageously allows merchandise 14 that is positioned in the main body viewing area 24 to be readily viewed from a position exterior the outer thematic facade 30. This also advantageously allows a plurality of users U to readily view and select merchandise 14 positioned within the main body 22 of the merchandise dispensing device.

The outer thematic facade 30 can advantageously be detachably connected to portions of the main body 22 of the merchandise dispensing device 20, as best illustrated in FIG. 4. The outer thematic facade 30 can also include a plurality of outer thematic facades 30 that can be interchangeably detachably connected to the main body 20. Each one of the plurality of outer thematic facades 30 are substantially different and can therefore correspond to a different preselected environment 12. This advantageously allows the main body 22 of the merchandise dispensing device 20 to be positioned in any one of a plurality of preselected environments 12. For example, the main body 22 of the merchandise dispensing device 20 can initially be positioned in a theme park and include an outer thematic facade 30 corresponding to that theme park. The main body 22 of the merchandise dispensing device 20 can then be moved to a museum, for example, and have another outer thematic facade 30 corresponding to that museum detachable connected thereto.

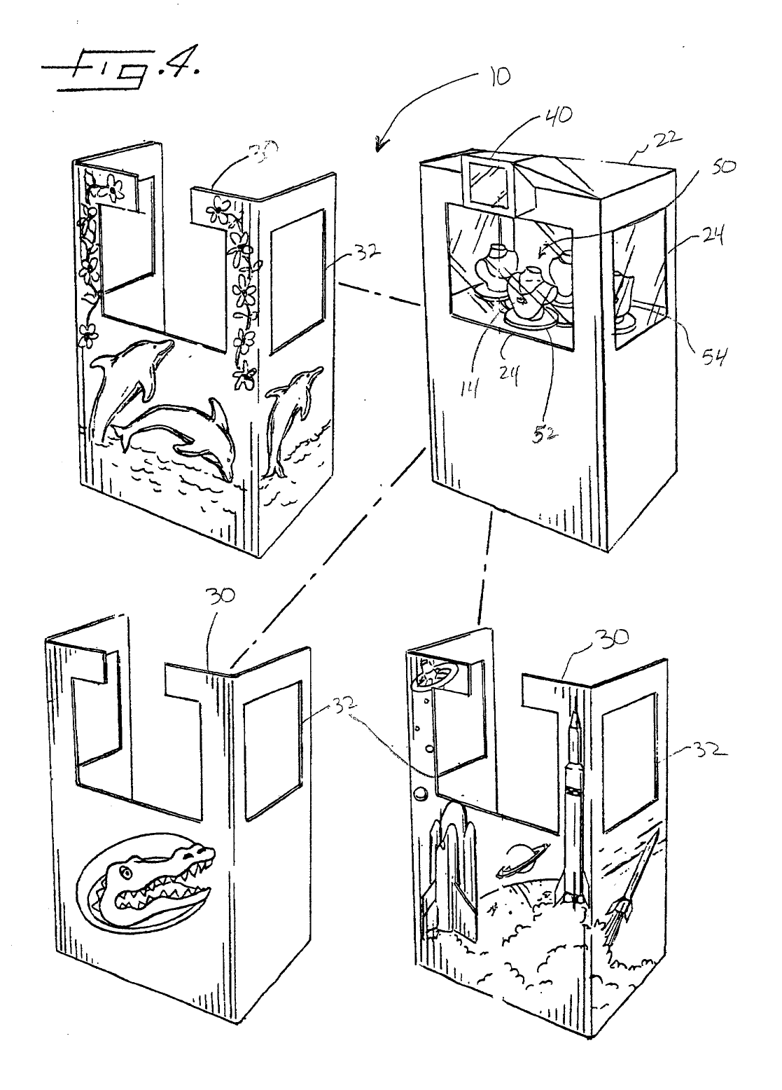

As best illustrated in FIGS. 5-7, the merchandise dispensing device 20 of the present invention can further advantageously include a display device 40 that is preferably positioned along portions of the outer thematic facade 30. The display device 40 can also, however, be positioned along portions of the main body 22 of the merchandise dispensing device 20. This advantageously allows the main body 22 to include a display device 40, regardless of whether an outer thematic facade 30 is connected thereto. In a case where the display device 40 is positioned on the main body 22 of the merchandise dispensing device 20, the outer thematic facades 30 can advantageously include an opening adapted to fit over the display device 40. This advantageously allows for a main body 22 having a display device 40 connected thereto to receive an outer thematic facade without obstructing the preselected images projected on the display device 40. The display device 40 can advantageously be a television screen, a computer monitor, or any other device capable of projecting an image, as understood by those skilled in the art.

The display device 40 can advantageously be positioned to project preselected images to users U positioned in the general area of the merchandise dispensing device 20. The preselected images projected on the display device 40 can advantageously be used to draw the attention of the users U to the merchandise dispensing device 20. The display device 40 can advantageously be positioned perpendicular to a support surface on which the merchandise dispensing device is positioned, i.e., the floor of the museum, so that the preselected images are projected outwardly to users U positioned a distance away from the merchandise dispensing device 20. The display device 40 can also advantageously be positioned with a downward tilt so as to project images to users U positioned closely adjacent the merchandise dispensing device 20.

The preselected images projected on the display device 40 can advantageously be associated with the predetermined environment 12 in which the merchandise dispensing device 20 is positioned. For example, if the merchandise dispensing device 20 is positioned in a theme park and has an outer thematic facade 30 corresponding to that theme park, the images projected on the display device 40 can advantageously be a movie or cartoon associated with the theme park. Also for example, if the merchandise dispensing device 20 is positioned on a college campus, the display device 40 can project images related to the school athletic teams, i.e., the basketball game from the prior weekend.

The preselected images projected on the display device 40 can also advantageously be associated with each of the plurality of articles of merchandise 14 positioned in the main body 22 of the merchandise dispensing device 20. The images can include details of the specifications of each of the plurality of articles of merchandise 14. For example, if the merchandise 14 positioned in the main body 22 of the merchandise dispensing device 40 is jewelry, i.e., necklaces, bracelets, or watches, then, the preselected images can show various details of the jewelry, i.e., different views of the jewelry, the jewelry being modeled on other persons, or the capabilities of the jewelry, i.e., a water resistant watch being worn in a pool.

As illustrated in FIG. 1, the merchandise dispensing device 20 of the present invention can also advantageously include payment receiving means. The payment receiving means can advantageously be provided by a payment receiver 42, such as a credit card reader, a debit card reader, a cash acceptor, or any other payment receiver 42 that is capable of accepting a predetermined payment for at least one article of merchandise 14 positioned withing the merchandise dispensing device 20. The payment receiving means can be positioned to connect to portions of the main body 22 of the merchandise dispensing device 20 for receiving a predetermined payment for at least one of the plurality of articles of merchandise 14 positioned in the main body 22 of the merchandise dispensing device 20.

The merchandise dispensing device 20 of the present invention can further advantageously include a user interface 44 responsive to a user U and positioned along portions of the main body 22 so that a user U can select one of the plurality of articles of merchandise 14 to be viewed and purchased. The user interface 44 can include a plurality of buttons or exterior controls for selecting one of the plurality of articles of merchandise. Although the user interface 44 can be positioned on any portion of the main body 22, it is preferable to position the user interface 44 on a side portion of the main body 22. This advantageously eliminates any discontinuity in the aesthetical appearance of the preselected environment 12. The outer thematic facade 30 can also advantageously include openings that would align with the user interface 44 when the outer thematic facade 30 is positioned to connect to the main body 22. This advantageously eliminates any obstruction of the user interface 44 by the thematic facade 30.

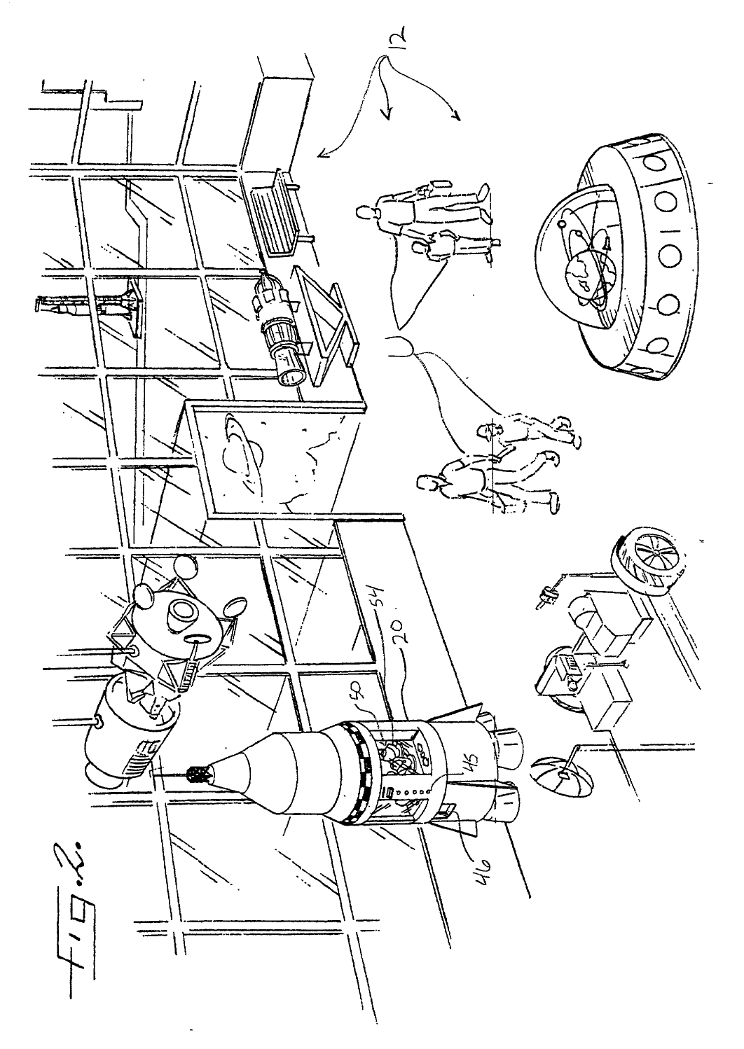

As best illustrated in FIG. 3, the merchandise dispensing device 20 still further advantageously includes dispensing means positioned to connect to portions of the main body 22 for dispensing at least one of the plurality of articles of merchandise 14 selected by a user U. The dispensing means can advantageously be provided by a dispenser 46. The dispenser 46 can advantageously be a chute or pathway, for example, that allows at least one of the plurality of articles of merchandise 14 to be dispensed to a user U after being purchased. The dispenser 46 can also advantageously include security measures, such as a door that can only be opened when merchandise 14 is dispensed, or a chute that includes many curves to prevent items from being forced into the dispenser 46 from a position exterior the merchandise dispensing device 20. This advantageously decreases the risk of theft of the merchandise 14 positioned within the main body 22 of the merchandise dispensing device 20. The outer thematic facade 30 can advantageously include openings corresponding to the dispenser 46 so that the dispenser 46 is not obstructed when the outer thematic facade 30 is positioned to connect to the main body 22 of the merchandise dispensing device 20.

As also illustrated in FIG. 3, the merchandise dispensing device 20 of the present invention can also advantageously include rotatable display means positioned within the main body 22, adjacent the at least one main body viewing area 24 for rotatably displaying the plurality of articles of merchandise 14 positioned in the main body 22 of the merchandise dispensing device 20. The rotatable display means advantageously provides a user U positioned exterior the merchandise dispensing device 20 with a view of many perspectives of the merchandise 14 positioned in the main body 22 of the merchandise dispensing device 20. The rotatable display means can advantageously be provided by a rotatable display 50. The rotatable display 50 advantageously allows the plurality of articles of merchandise 14 to be rotated and displayed along the various sides of the merchandise dispensing devise 20.

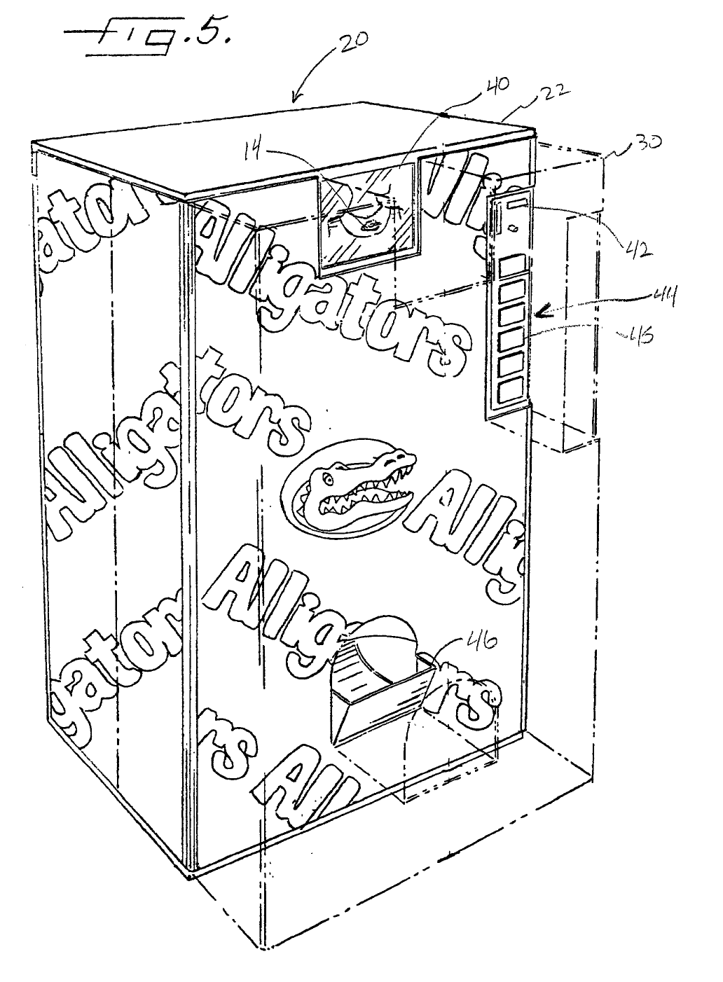

As best illustrated in FIGS. 3 and 6, the rotatable display 50 can advantageously include a rotatable display area 52 positioned within the main body 22 of the merchandise dispensing device 20. The rotatable display area 52 can be a rotatable shelf, for example, that rotates in a first predetermined direction L, i.e., clockwise with respect to the main body 22 of the merchandise dispensing device 20. The rotatable display 50 can also advantageously include a plurality of display instruments 54. Each of the plurality of display instruments 54 can be rotatably connected to the rotatable display area 52. If the merchandise 14 being dispensed from the merchandise dispensing device 20 is jewelry, for example, then the plurality of display instruments 54 can advantageously be busts for displaying necklaces, or hands for displaying watches and rings. The rotatably connected display instruments 54 advantageously allow each of the plurality of articles of merchandise 14 to be rotated in a second predetermined direction R, i.e., counter-clockwise with respect to the main body 22 of the merchandise dispensing device 20, while the rotatable display area 52 is simultaneously rotated in the first second predetermined direction L. Therefore, for example, as the rotatable display area 52 is rotated in a clockwise direction, each of the plurality of rotatably connected display instruments 54 are simultaneously rotated in a counter-clockwise direction. This advantageously provides a user U with many views of the merchandise 14 positioned in the merchandise dispensing device 20. For example, if the merchandise 14 includes a watch, the user U is given the opportunity to see the front, back, and sides of the watch before making the decision to purchase the watch.

The rotation of the plurality of display instruments 54 can advantageously occur at a different rate of rotation than the rotation rate of the rotatable display area 52. For example, if the rotatable display area 52 is rotating a first predetermined rate of rotation, each of the rotatable display instruments 54 can be rotating at a second predetermined rate of rotation, i.e., a faster rate of rotation. This advantageously provides users U positioned exterior the merchandise dispensing device 20 with a view from many different perspectives of each of the plurality of articles of merchandise 14 positioned in the main body 22 of the merchandise dispensing device 20.

The user interface 44 can advantageously be used to control the rotation of each of the plurality of articles of merchandise 14. For example, as one of the plurality of articles of merchandise 14 is about to pass before the user U, positioned exterior the merchandise dispensing device 20, the user U can engage the user interface 44, i.e., push a button of the user interface 44, to stop or slow down the rotation of the article of merchandise 14 so that a better inspection of the article of merchandise 14 can be performed before making the decision to purchase the merchandise 14.

The merchandise dispensing device 20 of the present invention can also advantageously include an inventory storage hold 60 positioned in the main body 22. The inventory storage hold 60 can advantageously be a secured inventory storage hold 60, e.g., a vault. If, for example, the merchandise positioned in the merchandise dispensing device 20 is valuable merchandise, such as jewelry, then a secured inventory storage hold 60 advantageously reduces the risk of theft.

The plurality of articles of merchandise 14 positioned in the inventory storage hold 60 are articles of inventory merchandise 15 and the plurality of articles of merchandise 14 positioned closely adjacent the main body viewing area 24 are articles of display merchandise 16. The articles of inventory merchandise 15 correspond to the articles of display merchandise 16. For example, if the display merchandise 16 includes necklaces, bracelets, and watches, then the inventory merchandise 15 will include necklaces, bracelets, and watches having substantially the same specifications, i.e., if a gold watch having a blue face is on display, then the same gold watch having a blue face will be positioned in the inventory storage hold 60.

The dispenser 46 of the merchandise dispensing device 20 is advantageously connected to the inventory storage hold 60 so that the articles of inventory merchandise 15 can be dispensed to a user U through the dispenser 46. Therefore, merchandise 14 that is substantially similar to the display merchandise 16 is advantageously taken from one of the plurality of articles of inventory merchandise 15 and dispensed to the user U through the dispenser 46.

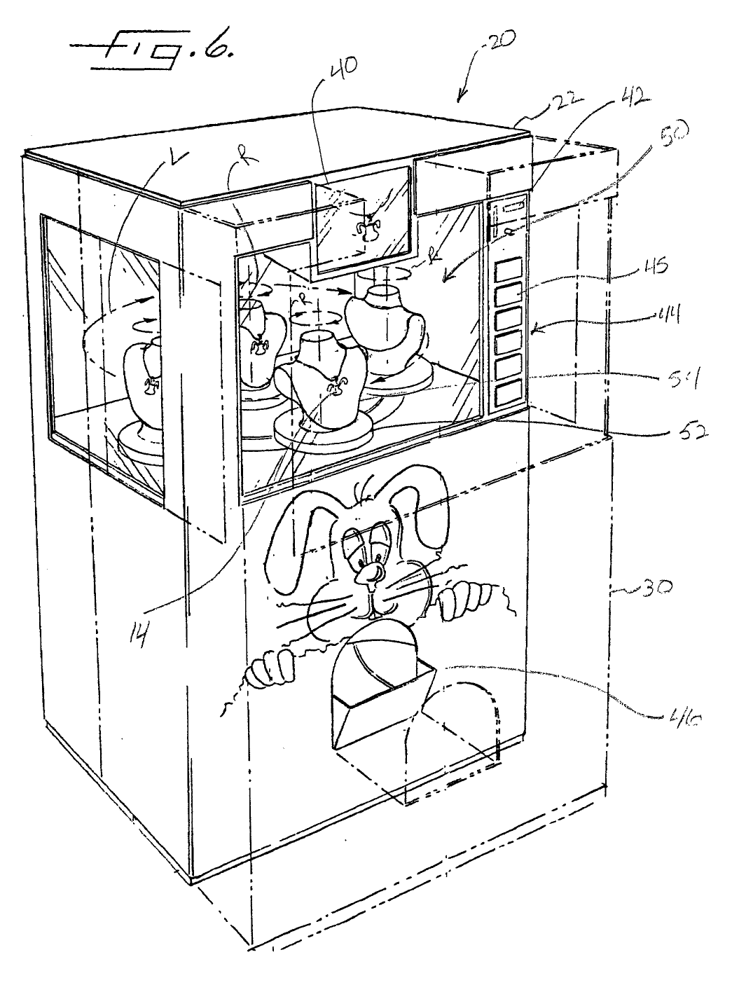

As best illustrated in FIG. 7, the merchandise dispensing device 20 can further advantageously include controlling means for controlling various functions of the merchandise dispensing device 20. The controlling means can advantageously be provided by a controller 70 positioned within the main body 22. The controller 70 can be an electronic switch, computer program, or any device or apparatus capable of controlling the functions of the merchandise dispensing device 20. The controller 70 can further advantageously be positioned in electrical communication with the rotatable display 50, the display device 40, the payment receiver 42, and the dispenser 46, to control the rotation of the rotatable display area 52 and the plurality of display instruments 54, and to activate and deactivate the display device 40, the payment receiver 42, and the dispenser 46. For example, the controller 70 can be used to project various images on the display device 40 at various times. The controller 70 can also be used to dispense at least one of the plurality of articles of merchandise 14 from the inventory storage hold 60 through the dispenser 46 upon recognition of a predetermined payment received by payment receiver 42.

The user interface 44 can advantageously be positioned in communication with the controller 70 and can further advantageously include a plurality of controls. A first plurality of controls, for example, can be used to stop the rotation of each of the plurality of articles of merchandise 14 positioned in the main body 22 of the merchandise dispensing device 20. For example, the controls can be used to stop the rotation of the rotatable display area 52, the rotatably connected display instruments 54, or both. The user interface 44 can also advantageously include a second plurality of controls for selecting one of the plurality of articles of display merchandise 16 for purchase. After the user U selects at least one of the articles of display merchandise 16 for purchase, a similar article of inventory merchandise 15 is dispensed to the user U positioned exterior the merchandise dispensing device 20.

As best illustrated in FIG. 9, the merchandise dispensing device 20 of the present invention can also advantageously include customization means positioned within the main body 22 for customizing the merchandise 14 positioned in the main body 22. The customization means can advantageously be provided by a customizer 80, such as an engraver, for example. Using the user interface 44, the user U can select an article of jewelry, for example, to be customized. The user U can then be prompted to enter the desired name or message to be engraved onto the article of jewelry. The customizer 80 can also be used to customize the length of a necklace, select a particular gem to be inserted into a ring, embroider a scarf, select a particular color ink for a pen, or any other type of customization to merchandise 14, as understood by those skilled in the art. The customizer 80 advantageously allows a user U to obtain customized merchandise 14 in a shorter period of time.

The present invention further includes a merchandise dispensing system 10 for dispensing merchandise 14. The merchandise dispensing system 10 can advantageously include a main body 22 positioned in a preselected environment 12. The main body 22 can advantageously include a plurality of articles of merchandise 14 positioned therein. The main body 22 can also advantageously include at least one main body viewing area 24, as described in detail above. The merchandise dispensing system 10 further advantageously includes a plurality of outer thematic facades 30 that can be interchangeably, detachably connected to the main body 22, as also described in detail above, and as illustrated in FIG. 4. The merchandise dispensing system 10 also advantageously includes dispensing means positioned to connect to portions of the main body 22 for dispensing at least one of the plurality of articles of merchandise 14 selected by a user U. As described above, the dispensing means can be provided by a dispenser 46, such as a chute or pathway for example that allows at least one of the plurality of articles of merchandise 14 to be dispensed to a user U after being purchased. As also described above, the outer thematic facades 30 can advantageously include openings corresponding to the dispenser 46 so that the dispenser 46 will not be obstructed when one of the plurality of outer thematic facades 30 is interchangeably and detachably connected to the main body 22.

Similar to the merchandise dispensing device 20 of the present invention, the merchandise dispensing system 10 further includes a display device, payment receiving means, a user interface, rotatable display means, an inventory storage hold, and a controller, all as described in detail above.

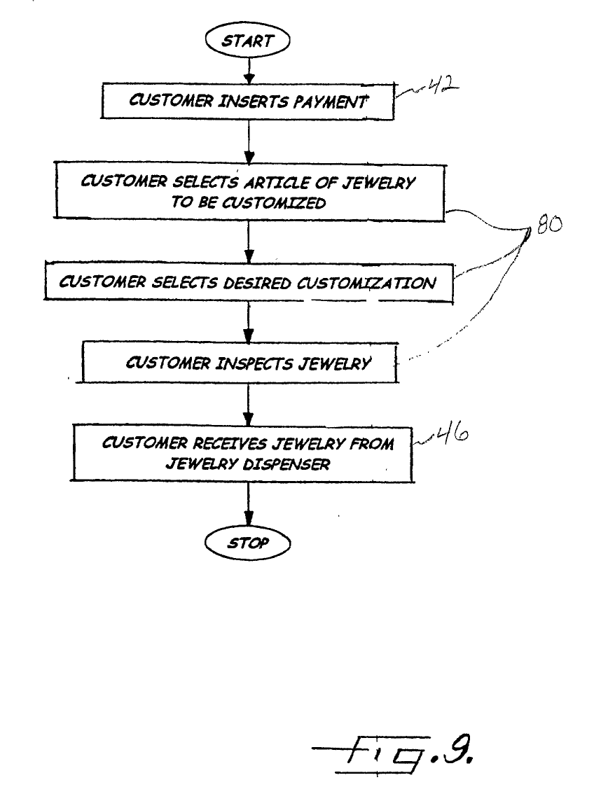

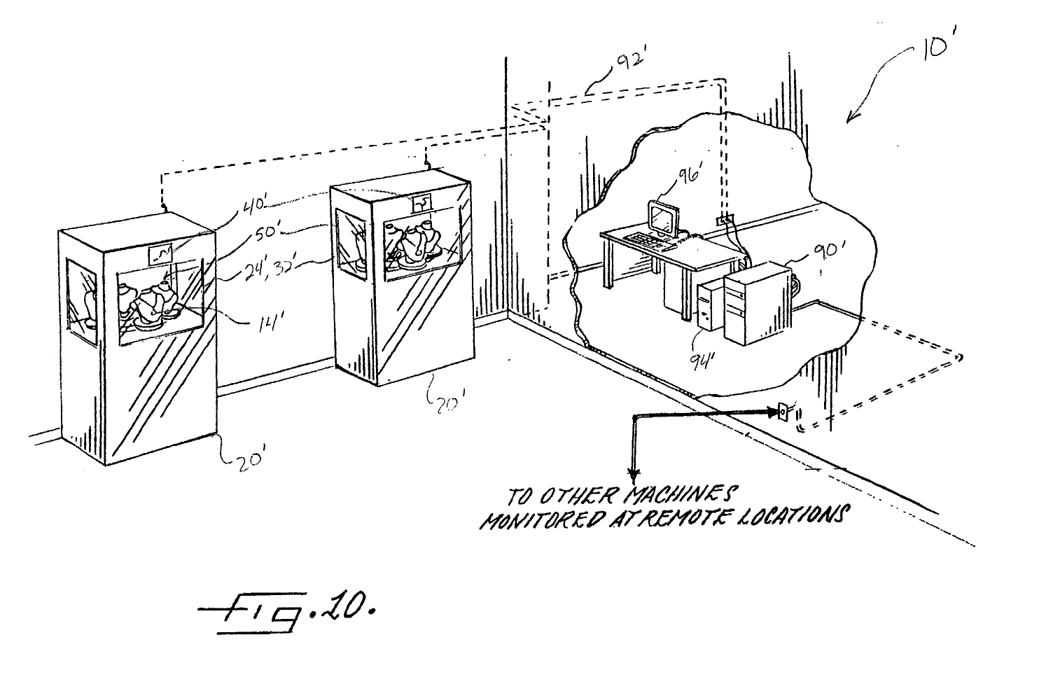

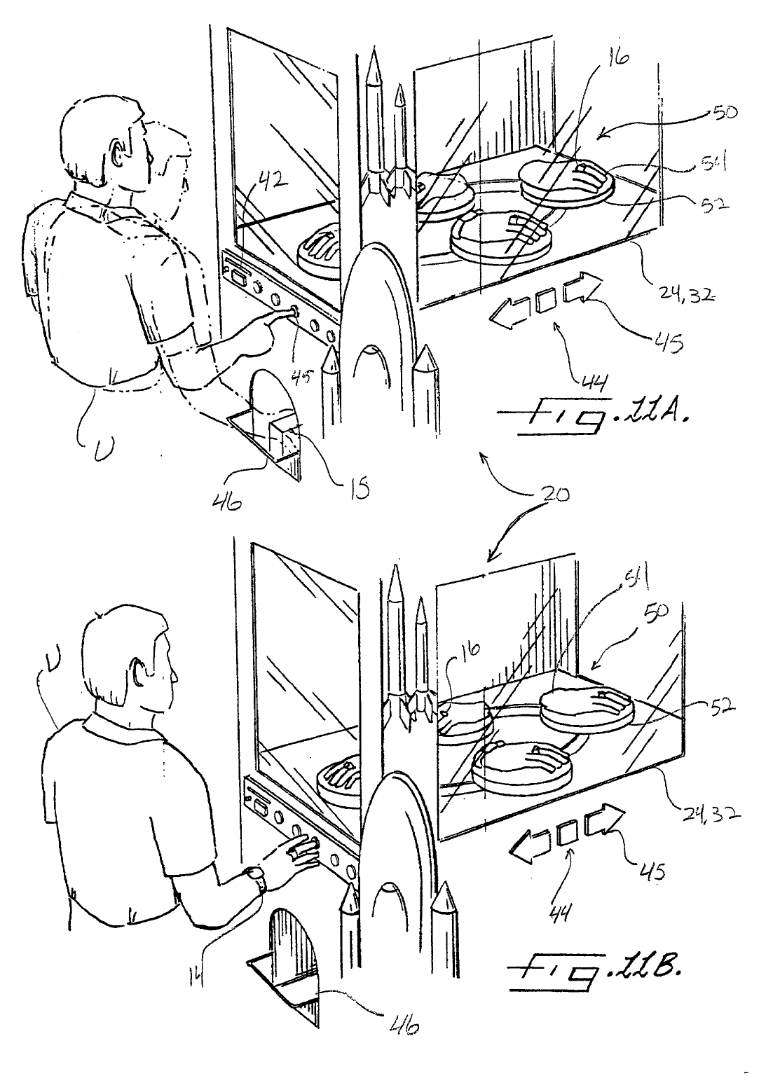

As illustrated in FIG. 10, a second embodiment of the merchandise dispensing system 10′ includes a server 90′ having a database and a communications network 92′ positioned in communication with the server 90′. The second embodiment of the merchandise dispensing system 10′ further includes a plurality of merchandise dispensing devices 20′, positioned in communication with the communications network 92′. The merchandise dispensing devices 20′ have been described in detail above.

The merchandise dispensing system 10′ can further advantageously include monitoring means positioned on the server 90′ and in communication with the communications network 92′ for monitoring the plurality of articles of merchandise 14′ positioned in the main body 22′ of each of the plurality of merchandise dispensing devices 20′. The monitoring means can be provided by a monitor 94′, such as a program positioned on the server 90′ and accessible by a computer 96′, for example, positioned in communication with the communications network 92′. The computer 96′ can be positioned at a remote location, or can be located adjacent the server 90′. This advantageously allows a system administrator to monitor a plurality of merchandise dispensing devices 20′ positioned in a plurality of different preselected environments 12′ from a remote computer positioned in communication with the communications network 92′.

The merchandise dispensing system 10 can also advantageously include an attendant positioned closely adjacent each of the merchandise dispensing devices 20. The attendant can also have access to the inventory storage hold 60 so that articles of merchandise 14 that a user U is not satisfied with, can be readily exchanged with a different article of merchandise. An attendant advantageously decreases the number of persons that contact the merchandise to thereby reduce the risk of theft.

The present invention also includes methods of dispensing at least one of a plurality of articles of merchandise 14 from a merchandise dispensing device 20. The methods can advantageously include displaying a plurality of articles of merchandise 14 within a main body 22 of one of a plurality of merchandise dispensing devices 20 and can further advantageously include rotating the plurality of articles of merchandise 14 on display in a first predetermined direction L. The methods can also advantageously include rotating each of the plurality of articles of merchandise 14 on display in the merchandise dispensing device 20 in a second predetermined direction R so that each one of the plurality of articles of merchandise 14 is rotated in the second predetermined direction R while simultaneously rotating the plurality of articles of merchandise 14 in the first predetermined direction L. The methods can further advantageously include dispensing at least one of the plurality of articles of merchandise 14 to a user U.

As illustrated in FIG. 2, the method of dispensing merchandise 14 can also advantageously include positioning at least one merchandise dispensing device 20 in a predetermined environment 12. The method further includes connecting an outer thematic facade 30 to portions of a main body 22 of a merchandise dispensing device 20 so that the merchandise dispensing device 20 corresponds to the predetermined environment 12.

The method of dispensing merchandise 14 can further include controlling the rotation of the plurality of articles of merchandise 14 in the merchandise dispensing device 20 by engaging a user interface 44. A user U, positioned exterior the merchandise dispensing device 20, can engage the user interface 44 to stop or start the rotation of each of the plurality of articles of merchandise 14, and can also engage the user interface 44 to pay for and dispense one of the plurality of articles of merchandise 14. The method can still further advantageously include selecting at least one article of merchandise 14 by engaging the user interface 44.

The method of dispensing merchandise 14 can also advantageously include monitoring inventory and payments received of each of a plurality of merchandise dispensing devices 20 from a remote location. This can be accomplished by communicating with a server 90′ that is in communication with each of the plurality of merchandise dispensing devices 20′ to monitor the condition of each merchandise dispensing device 20′, the inventory, the payments received, or any malfunctions that occur with each of the plurality of merchandise dispensing devices 20′.

The method of dispensing merchandise 14 can also advantageously include interchangeably and detachably connecting one of a plurality of outer thematic facades 30 to the main body 22 of the merchandise dispensing device 20 so that the merchandise dispensing device 20 corresponds to the preselected environment 12 in which the merchandise dispensing device 20 is positioned. This advantageously allows the main body 22 of the merchandise dispensing device 20 to be positioned in a plurality of preselected environments 12.

The method of dispensing merchandise 14 can further advantageously include displaying preselected images on a display device 40 to draw the attention of users U to the merchandise dispensing device 20. The preselected images can advantageously correspond to the preselected environment 12 in which the merchandise dispensing device 20 is positioned, or can correspond to the merchandise 14 positioned in each of the plurality of merchandise dispensing devices 20.

The method of dispensing merchandise 14 from a merchandise dispensing device can still further advantageously include dispensing jewelry from a merchandise dispensing device 20. The method can further include displaying a plurality of articles of display jewelry in a merchandise dispensing device 20. Each of the plurality of articles of display jewelry are substantially different so that users U can advantageously select from a variety of articles of jewelry. The method further includes dispensing one of a plurality of articles of inventory jewelry from an inventory storage hold 60. As described in detail above, each one of the plurality of articles of inventory jewelry corresponds to one of the plurality of articles of display jewelry so that the articles of inventory jewelry that are dispensed to a user are substantially similar to the articles of display jewelry that are displayed to a user.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification and as defined in the appended claims.

That claimed is:

1. A merchandise dispensing device positioned in a preselected environment for dispensing merchandise, the merchandise dispensing device comprising:
a main body having a plurality of articles of merchandise positioned therein and including at least one main body viewing area that is substantially transparent so that the plurality of articles of merchandise can be readily viewed from a position exterior the main body;
an outer thematic facade connected to and substantially covering portions of the main body, the outer thematic facade corresponding to the preselected environment so that the outer thematic facade has an appearance that blends into the preselected environment, the outer thematic facade including at least one outer thematic facade viewing area that is substantially transparent and positioned to align with the at least one main body viewing area so that the plurality of articles of merchandise positioned in the main body can be readily viewed from a position exterior the outer thematic facade;
a display device positioned along portions of the outer thematic facade for displaying preselected images to users to thereby draw the attention of users to the merchandise dispensing device;
payment receiving means positioned to connect to portions of the main body for receiving a predetermined payment for at least one of the plurality of articles of merchandise;
a user interface responsive to a user and positioned along portions of the main body so that a user can select one of the plurality of articles of merchandise to be viewed and purchased; and
dispensing means positioned to connect to portions of the main body for dispensing at least one of the plurality of articles of merchandise selected by a user.

2. The merchandise dispensing device as defined in claim 1, wherein the display device is a display monitor for displaying images associated with the preselected environment in which the merchandise dispensing device is positioned.

3. The merchandise dispensing device as defined in claim 1, wherein the display device is a display monitor for displaying images of each of the plurality of articles of merchandise positioned within the main body of the merchandise dispensing device.

4. The merchandise dispensing device as defined in claim 3, further comprising rotatable display means positioned within the main body adjacent the at least one main body viewing area for rotatably displaying the plurality of articles of merchandise positioned in the main body.

5. The merchandise dispensing device as defined in claim 4, wherein the rotatable display means further comprises a rotatable display area positioned within the main body and a plurality of rotatably connected display instruments each having at least one of the plurality of articles of merchandise positioned thereon for display, the rotatable display area positioned to rotate in a first predetermined direction and each of the plurality of display instruments positioned to rotate in a second predetermined direction so that each of the plurality of display instruments rotates in the second predetermined direction simultaneously as the rotatable display area rotates in the first predetermined direction.

6. The merchandise dispensing device as defined in claim 5, further comprising an inventory storage hold positioned in the main body, wherein each of the plurality of articles of merchandise further comprise articles of inventory merchandise positioned in the inventory storage hold and articles of display merchandise positioned closely adjacent both the at least one main body viewing area and the at least one outer facade viewing area for ready viewing by a user, the articles of inventory merchandise being substantially similar to the articles of display merchandise.

7. The merchandise dispensing device as defined in claim 6, wherein the dispensing means is connected to the inventory storage hold so that the articles of inventory merchandise are dispensed to a user through the dispensing means.

8. The merchandise dispensing device as defined in claim 7, further comprising a controller positioned within the main body and in electrical communication with the rotatable display means, the display device, the payment receiving means, and the dispensing means, to control the rotation of the rotatable display area and the plurality of display instruments, and to activate and deactivate the display monitor, the payment receiving means, and the dispensing means.

9. The merchandise dispensing device as defined in claim 8, wherein the user interface further comprises a first plurality of controls positioned in communication with the controller for readily viewing the display merchandise by stopping the rotation thereof, and a second plurality of controls positioned in communication with the controller for selecting one of the plurality of articles of display merchandise to be purchased and dispensed.

10. The merchandise dispensing device as defined in claim 9, wherein the outer thematic facade is detachably connected to portions of the main body, and wherein the outer thematic facade further comprises a plurality of outer thematic facades that can be interchangeably detachably connected to the main body, each one of the plurality of outer thematic facades corresponding to a different preselected environment so that the main body of the merchandise dispensing device can be positioned in any one of a plurality of preselected environments.

11. The merchandise dispensing device as defined in claim 10, wherein the plurality of articles of merchandise further comprise at least one of the following: watches, rings, necklaces, bracelets, scarves, perfumes, colognes, pens, pencils, T-shirts, cuff links, purses, wallets, and sunglasses.

12. A merchandise dispensing device for dispensing merchandise, the merchandise dispensing device comprising:
a main body having a plurality of articles of merchandise positioned therein;
at least one main body viewing area positioned on the main body, the at least one main body viewing area being substantially transparent so that the plurality of articles of merchandise positioned within the main body is readily viewable from a position exterior the main body;
rotatable displaying means positioned within the main body for rotatably displaying the plurality of articles of merchandise positioned in the main body;
payment receiving means positioned along outer portions of the main body for receiving a predetermined payment for at least one of the plurality of articles of merchandise;
a user interface responsive to a user and positioned along outer portions of the main body so that a user can select one of the plurality of articles of merchandise to be viewed and purchased; and
dispensing means positioned along outer portions of the main body for dispensing at least one of the plurality of articles of merchandise.

13. The merchandise dispensing device as defined in claim 12, wherein the rotatable display means further comprises a rotatable display area positioned within the main body and a plurality of rotatably connected display instruments, each having at least one of the plurality of articles of merchandise positioned thereon for display, the rotatable display area positioned to rotate in a first predetermined direction and each of the plurality of display instruments positioned to rotate in a second predetermined direction so that each of the plurality of display instruments rotates in the second predetermined direction simultaneously as the rotatable display area rotates in the first predetermined direction.

14. The merchandise dispensing device as defined in claim 13, wherein the merchandise dispensing device is positioned in a preselected environment and further comprising an outer thematic facade connected to and substantially covering portions of the main body, the outer thematic facade corresponding to the preselected environment so that the outer thematic facade has an appearance that blends into the preselected environment.

15. The merchandise dispensing device as defined in claim 14, wherein the outer thematic facade is detachably connected to portions of the main body, and wherein the outer thematic facade further comprises a plurality of outer thematic facades that can be interchangeably detachably connected to the main body, each one of the plurality of outer thematic facades corresponding to a different preselected environment so that the main body of the merchandise dispensing device can be positioned in any one of a plurality of preselected environments.

16. The merchandise dispensing device as defined in claim 15, further comprising a display device positioned along portions of the outer thematic facade for displaying preselected images to users to thereby draw the attention of users to the merchandise dispensing device.

17. The merchandise dispensing device as defined in claim 16, wherein the display device is a display monitor for displaying images associated with the preselected environment in which the merchandise dispensing device is positioned.

18. The merchandise dispensing device as defined in claim 17, further comprising at least one outer thematic facade viewing area positioned along outer portions of each of the plurality of outer thematic facades, the at least one outer thematic facade viewing area being substantially transparent and positioned to substantially align with the main body viewing area to thereby allow ready viewing of the plurality of articles of merchandise positioned within the main body.

19. The merchandise dispensing device as defined in claim 18, further comprising an inventory storage hold positioned in the main body, wherein each of the plurality of articles of merchandise further comprise articles of inventory merchandise positioned in the inventory storage hold and articles of display merchandise positioned closely adjacent both the at least one main body viewing area and the at least one outer facade viewing area for ready viewing by a user, the articles of inventory merchandise being substantially similar to the articles of display merchandise.

20. The merchandise dispensing device as defined in claim 19, wherein the dispensing means is connected to the inventory storage hold so that the articles of inventory merchandise are dispensed to a user through the dispensing means.

21. The merchandise dispensing device as defined in claim 20, further comprising controlling means positioned within the main body and in electrical communication with the rotatable display means, the display device, the payment receiving means, and the dispensing means, for controlling the rotation of the rotatable display area and the plurality of display instruments, and for activating and deactivating the display monitor, the payment receiving means, and the dispensing means.

22. The merchandise dispensing device as defined in claim 21, wherein the user interface further comprises a first plurality of controls positioned in communication with the controller for readily viewing the display merchandise by stopping the rotation thereof, and a second plurality of controls positioned in communication with the controller for selecting one of the plurality of articles of display merchandise to be purchased and dispensed.

23. The merchandise dispensing device as defined in claim 22, wherein the plurality of articles of merchandise further comprise at least one of the following: watches, rings, necklaces, bracelets, scarves, perfumes, colognes, pens, pencils, T-shirts, cuff links, purses, wallets, and sunglasses.

24. A merchandise dispensing system for dispensing merchandise, the merchandise dispensing system comprising:
a main body positioned in a preselected environment, the main body having a plurality of articles of merchandise positioned therein and including at least one main body viewing area that is substantially transparent so that the plurality of articles of merchandise can be readily viewed from a position exterior the main body;
a plurality of outer thematic facades that can be interchangeably detachably connected to the main body, each of the plurality of outer thematic facades corresponding to a different preselected environment so that the main body can be positioned in any one of a plurality of preselected environments; and
dispensing means positioned to connect to portions of the main body for dispensing at least one of the plurality of articles of merchandise selected by a user.

25. The merchandise dispensing system as defined in claim 24, further comprising a display device positioned along portions of each one of the plurality of outer thematic facades for displaying preselected images to users to thereby draw the attention of users to the merchandise dispensing device.

26. The merchandise dispensing system as defined in claim 25, further comprising payment receiving means positioned to connect to portions of the main body for receiving a predetermined payment for at least one of the plurality of articles of merchandise.

27. The merchandise dispensing system as defined in claim 26, further comprising a user interface responsive to a user and positioned along portions of the main body so that a user can select one of the plurality of articles of merchandise to be viewed and purchased.

28. A merchandise dispensing system as defined in claim 27, wherein the display device is a display monitor for displaying images associated with the preselected environment in which the merchandise dispensing device is positioned.

29. A merchandise dispensing system as defined in claim 28, further comprising rotatable display means positioned within the main body adjacent the at least one main body viewing area for rotatably displaying the plurality of articles of merchandise positioned in the main body.

30. A merchandise dispensing system as defined in claim 29, wherein the rotatable display means further comprises a rotatable display area positioned within the main body and a plurality of rotatably connected display instruments each having at least one of the plurality of articles of merchandise positioned thereon for display, the rotatable display area positioned to rotate in a first predetermined direction and each of the plurality of display instruments positioned to rotate in a second predetermined direction so that each of the plurality of display instruments rotates in the second predetermined direction simultaneously as the rotatable display area rotates in the first predetermined direction.

31. A merchandise dispensing system as defined in claim 30, further comprising an inventory storage hold positioned in the main body, wherein each of the plurality of articles of merchandise further comprise articles of inventory merchandise positioned in the inventory storage hold and articles of display merchandise positioned closely adjacent both the at least one main body viewing area and the at least one outer facade viewing area for ready viewing by a user, the articles of inventory merchandise being substantially similar to the articles of display merchandise.

32. A merchandise dispensing system as defined in claim 31, wherein the dispensing means is connected to the inventory storage hold so that the articles of inventory merchandise are dispensed to a user through the dispensing means.

33. The merchandise dispensing system as defined in claim 32, further comprising a controller positioned within the main body and in electrical communication with the rotatable display means, the display device, the payment receiving means, and the dispensing means, to control the rotation of the rotatable display area and the plurality of display instruments, and to activate and deactivate the display monitor, the payment receiving means, and the dispensing means.

34. A merchandise dispensing system as defined in claim 33, wherein the user interface further comprises a first plurality of controls positioned in communication with the controller for readily viewing the display merchandise by stopping the rotation thereof, and a second plurality of controls positioned in communication with the controller for selecting one of the plurality of articles of display merchandise to be purchased and dispensed.

35. A merchandise dispensing system as defined in claim 34, wherein the plurality of articles of merchandise further comprise at least one of the following: watches, rings, necklaces, bracelets, scarves, perfumes, colognes, pens, pencils, T-shirts, cuff links, purses, wallets, and sunglasses.

36. A merchandise dispensing system for dispensing merchandise, the merchandise dispensing system comprising:
a server having a database;
a communications network positioned in communication with the server;
a plurality of merchandise dispensing devices, each positioned in one of a plurality of preselected environments and further positioned in communication with the communications network, each one of the plurality of merchandise dispensing devices including a main body and an outer thematic facade connected thereto, the main body having a plurality of articles of merchandise positioned therein, and the outer thematic facade including a display device connected along outer portions thereof for displaying preselected images to users to thereby draw the attention of users to each one of the plurality of merchandise dispensing devices, and further comprising dispensing means positioned to connect to portions of the main body for dispensing at least one of the plurality of articles of merchandise selected by a user; and
monitoring means positioned on the server and in communication with the communications network for monitoring the plurality of articles of merchandise positioned in the main body portion of each one of the plurality of merchandise dispensing devices.

37. The merchandise dispensing system as defined in claim 25, wherein the display device is a monitor for displaying images associated with the preselected environment in which each of the plurality of merchandise dispensing devices are positioned.

38. The merchandise dispensing system as defined in claim 37, wherein the main body of each of the plurality of dispensing devices further comprises at least one main body viewing area positioned along outer portions of the main body, and wherein the outer thematic facade further comprises at least one outer thematic facade viewing area positioned along outer portions of the outer thematic facade, the at least one main body viewing area and the at least one outer thematic facade viewing area being substantially transparent and positioned to align with one another so that each of the plurality of articles of merchandise positioned within the main body are readily viewable from a position exterior the outer thematic facade.

39. The merchandise dispensing system as defined in claim 38, wherein each of the plurality of merchandise dispensing devices further comprising rotatable display means positioned within the main body adjacent the at least one main body viewing area for rotatably displaying the plurality of articles of merchandise positioned in the main body.

40. The merchandise dispensing system as defined in claim 39, wherein the rotatable display means further comprises a rotatable display area positioned within the main body and a plurality of rotatably connected display instruments each having at least one of the plurality of articles of merchandise positioned thereon for display, the rotatable display area positioned to rotate in a first predetermined direction and each of the plurality of display instruments positioned to rotate in a second predetermined direction so that each of the plurality of display instruments rotates in the second predetermined direction simultaneously as the rotatable display area rotates in the first predetermined direction.

41. The merchandise dispensing system as defined in claim 39, further comprising an inventory storage hold positioned in the main body, wherein each of the plurality of articles of merchandise further comprise articles of inventory merchandise positioned in the inventory storage hold and articles of display merchandise positioned closely adjacent both the at least one main body viewing area and the at least one outer facade viewing area for ready viewing by a user, the articles of inventory merchandise being substantially similar to the articles of display merchandise.

42. The merchandise dispensing system as defined in claim 41, wherein the dispensing means is connected to the inventory storage hold so that the articles of inventory merchandise are dispensed to a user through the dispensing means.

43. The merchandise dispensing system as defined in claim 42, wherein each of the plurality of merchandise dispensing devices further comprise payment receiving means positioned to connect to portions of the main body for receiving a predetermined payment for at least one of the plurality of articles of merchandise.

44. The merchandise dispensing system as defined in claim 43, further comprising a controller positioned within the main body and in electrical communication with the rotatable display means, the display device, the payment receiving means, and the dispensing means, to control the rotation of the rotatable display area and the plurality of display instruments, and to activate and deactivate the display monitor, the payment receiving means, and the dispensing means.

45. The merchandise dispensing system as defined in claim 44, wherein each of the plurality of merchandise dispensing devices further comprise a user interface responsive to a user and positioned along potions of the main body of each of the plurality of merchandise dispensing devices so that a user can select one of the plurality of articles of merchandise to be viewed and purchased.

46. The merchandise dispensing system as defined in claim 45, wherein the user interface further comprises a first plurality of controls positioned in communication with the controller for readily viewing the display merchandise by stopping the rotation thereof, and a second plurality of controls positioned in communication with the controller for selecting one of the plurality of articles of display merchandise to be purchased and dispensed.

47. The merchandise dispensing system as defined in claim 46, wherein the outer thematic facade is detachably connected to portions of the main body, and wherein the outer thematic facade further comprises a plurality of outer thematic facades that can be interchangeably detachably connected to the main body, each one of the plurality of outer thematic facades corresponding to a different preselected environment so that the main body of the merchandise dispensing device can be positioned in any one of a plurality of preselected environments.

48. The merchandise dispensing system as defined in claim 47, wherein the plurality of articles of merchandise further comprise at least one of the following: watches, rings, necklaces, bracelets, scarves, perfumes, colognes, pens, pencils, T-shirts, cuff links, purses, wallets, and sunglasses.

49. A merchandise dispensing device for dispensing jewelry, the merchandise dispensing device comprising:
a main body having at least one substantially transparent viewing area;
a display area positioned within the main body and having a plurality of articles of display jewelry positioned thereon, each one of the plurality of articles of display jewelry being substantially different;
an inventory hold positioned within the main body and having a plurality of articles of inventory jewelry positioned therein, each one of the plurality of articles of inventory jewelry corresponding to one of the plurality of articles of display jewelry; and
dispensing means positioned to connect to portions of the main body for dispensing at least one of the articles of inventory jewelry so that the article of display jewelry selected by a user is substantially similar to the article of inventory jewelry dispensed to the user.

50. The merchandise dispensing device as defined in claim 49, wherein each of the plurality of articles of inventory merchandise are organized so that similar articles of inventory merchandise are positioned closely adjacent each other.

51. The merchandise dispensing device as defined in claim 50, further comprising a display device positioned along portions of the main body for displaying preselected images to users to thereby draw the attention of users to the merchandise dispensing device.

52. The merchandise dispensing device as defined in claim 51, further comprising payment receiving means positioned to connect to portions of the main body for receiving a predetermined payment for at least one of the plurality of articles of inventory jewelry.

53. The merchandise dispensing device as defined in claim 52, further comprising a user interface responsive to a user and positioned along portions of the main body so that a user can select one of the plurality of articles of display merchandise to be viewed and purchased.

54. A method of dispensing a plurality of articles of merchandise from a merchandise dispensing device, the method comprising:
rotating the plurality of articles of merchandise on display in the merchandise dispensing device in a first predetermined direction;
rotating each of the plurality of articles of merchandise on display in the merchandise dispensing device in a second predetermined direction so that each one of the plurality of articles of merchandise is rotated in the second predetermined direction while simultaneously rotating the plurality of articles of merchandise in the first predetermined direction; and
dispensing at least one of the plurality of articles of merchandise to a user.

55. The method as defined in claim 54, further comprising controlling the rotation of the plurality of articles of merchandise in the merchandise dispensing device by engaging a user interface.

56. The method as defined in claim 55, further comprising selecting at least one article of the plurality of articles of merchandise by engaging the user interface.

57. The method as defined in claim 56, further comprising monitoring inventory of the merchandise dispensing device from a remote location.

58. A method of dispensing merchandise from a merchandise dispensing device positioned in one of a plurality of preselected environments, the method comprising:
displaying a plurality of articles of merchandise within a main body of a merchandise dispensing device;
interchangeably and detachably connecting one of a plurality of outer thematic facades to the main body of the merchandise dispensing device so that the merchandise dispensing device corresponds to the preselected environment in which the merchandise dispensing device is positioned; and
dispensing at least one of the plurality of articles of merchandise to a user.

59. The method as defined in claim 58, further comprising displaying preselected images on a display device to draw the attention of users to the merchandise dispensing device.

60. The method as defined in claim 59, further comprising rotating the plurality of articles of merchandise on display within the main body of the merchandise dispensing device.

61. The method as defined in claim 60, further comprising rotating each of the plurality of articles of merchandise on display in the main body of the merchandise dispensing device in a second predetermined direction so that each one of the plurality of articles of merchandise is rotated in the second predetermined direction while simultaneously rotating the plurality of articles of merchandise in the first predetermined direction.

62. A method of dispensing jewelry from a merchandise dispensing device, the method comprising:
displaying a plurality of articles of display jewelry in a merchandise dispensing device, each of the plurality of articles of display jewelry being substantially different; and
dispensing one of a plurality of articles of inventory jewelry from an inventory hold, each one of the plurality of articles of inventory jewelry corresponding to one of the plurality of articles of display jewelry so that the articles of inventory jewelry that are dispensed to a user are substantially similar to the articles of display jewelry that are displayed to a user.

63. The method as defined in claim 62, wherein the step of displaying a plurality of display jewelry further comprises rotatably displaying each of the plurality of articles of jewelry in a display area.

64. The method as defined in claim 63, wherein the step of rotatably displaying each of the plurality of articles of jewelry further comprises rotating the plurality of articles of jewelry in a first predetermined direction and rotating each of the plurality of articles of jewelry in a second predetermined direction while simultaneously rotating the plurality of articles of jewelry in the first predetermined direction.
